(19) United States
(12) Patent Application Publication
(10) Pub. No.: US 2025/0280085 A1
(43) Pub. Date: Sep. 4, 2025

(54) INFORMATION PROCESSING SYSTEM, NON-TRANSITORY COMPUTER-READABLE STORAGE MEDIUM, AND INFORMATION PROCESSING METHOD

(71) Applicant: FUJIFILM Business Innovation Corp., Tokyo (JP)

(72) Inventors: Masahiko Harada, Kanagawa (JP); Sho Nagase, Kanagawa (JP); Atsushi Mori, Kanagawa (JP)

(73) Assignee: FUJIFILM Business Innovation Corp., Tokyo (JP)

(21) Appl. No.: 18/782,695

(22) Filed: Jul. 24, 2024

(30) Foreign Application Priority Data
Mar. 4, 2024 (JP) 2024-031890

(51) Int. Cl. H04N 1/00

(52) U.S. Cl. CPC H04N 1/00891

(57) ABSTRACT

An information processing system includes a processor, a first storage device that is volatile and does not lose data with energization in a power saving mode, and a second storage device and a third storage device that are volatile and subjected to a refresh control in the power saving mode, wherein the processor, when activated, loads, into the first storage device, a first module having a function of detecting an interrupt due to reception of data among modules formed by dividing an operating system according to a function of the operating system, loads, into the second storage device, a second module having a function of controlling communication between hardware and software in response to a request from the first module, loads, into the third storage device, a third module having a function of processing the data or operating an application for processing the data in response to a request from the second module, causes the second storage device and the third storage device to perform a refresh operation in the power saving mode, and when the interrupt is detected by the first module in the power saving mode, cancels refresh of a storage device among the second storage device and the third storage device in which a module required for processing the data is loaded.

### CROSS-REFERENCE TO RELATED APPLICATIONS

This application is based on and claims priority under 35 USC 119 from Japanese Patent Application No. 2024-031890 filed Mar. 4, 2024.

### BACKGROUND

### (i) Technical Field

The present invention relates to an information processing system, a non-transitory computer-readable storage medium, and an information processing method.

### (ii) Related Art

Conventionally, there are many cases where a multifunction machine has a function of automatically shifting to a power saving state called a power saving mode, a sleep mode, or the like in order to reduce power consumption when a state where the multifunction machine does not operate continues for a predetermined time during normal operation. That is, as an operation mode, a power saving mode for operating in a power saving state is provided separately from a normal mode at the time of normal operation. When an operation panel is operated by a user in the power saving state, the multifunction machine automatically returns from the power saving state to a normal state where the multifunction machine can be used.

An information processing apparatus such as a personal computer (hereinafter, referred to as “PC”) may request a multifunction machine to perform processing such as checking of the status of the multifunction machine and printing via a network. Thus, it is necessary to respond to a request via a network even in the power saving state, and various technologies for this purpose have been proposed.

For example, JP444032B proposes an image forming apparatus that can make a response about a status with less power and at low cost even in a power saving state.

FIG. 6 is a schematic block diagram illustrating a main part of a controller 200 on which a plurality of CPUs are mounted as disclosed in JP444032B. The controller 200 includes a main CPU 202, a storage 4, a boot ROM 6, a sub CPU 204, a DRAM power saving control function 206, a DRAM 10, and a SRAM 20, and these are connected to a control line 8. The DRAM 10 is connected to the control line 8 via the DRAM power saving control function 206. The main CPU 202 performs overall control of the image forming apparatus in the normal mode. The sub CPU 204 does not adopt more complicated logic than the main CPU 202 but can operate in a state of low power consumption by reducing a memory size. When the conventional controller 200 shifts to the power saving mode, only the sub CPU 204 among the multiple CPUs is energized to execute processing such as status monitoring, thereby achieving both response to the outside and power saving.

### SUMMARY

When a plurality of processors are used to realize both response to the outside and power saving, the configuration of hardware or software becomes complicated to realize the cooperation between the processors. Therefore, when possible, a configuration with a single processor is desirable.

On the other hand, when the entire operating system is loaded into one volatile storage device in the case of the configuration with a single processor, the entire volatile storage device needs to be continuously energized even after the shift to the power saving mode, and thus a reduction in power to be supplied to the volatile storage device cannot be expected.

Aspects of non-limiting embodiments of the present disclosure relate to an improvement of the power saving effect as compared with the case where the entire operating system operating on a single processor is loaded into a single volatile storage device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising a processor, a first storage device that is volatile and does not lose data with energization in a power saving mode, and a second storage device and a third storage device that are volatile and subjected to a refresh control in the power saving mode, wherein the processor, when activated, loads, into the first storage device, a first module having a function of detecting an interrupt due to reception of data among modules formed by dividing an operating system according to a function of the operating system, loads, into the second storage device, a second module having a function of controlling communication between hardware and software in response to a request from the first module, loads, into the third storage device, a third module having a function of processing the data or operating an application for processing the data in response to a request from the second module, causes the second storage device and the third storage device to perform a refresh operation in the power saving mode, and when the interrupt is detected by the first module in the power saving mode, cancels refresh of a storage device among the second storage device and the third storage device in which a module required for processing the data is loaded.

### BRIEF DESCRIPTION OF THE DRAWINGS

Exemplary embodiments of the present invention will be described in detail based on the following figures, wherein:

FIG. 1 is a schematic block configuration diagram illustrating a hardware configuration of an image forming apparatus according to an exemplary embodiment;

FIG. 2 is a block configuration diagram illustrating a controller according to the present exemplary embodiment;

FIG. 3 is a flowchart illustrating processing at the time of activation according to the exemplary embodiment;

FIG. 4 is a diagram illustrating a relationship between a physical address space and a virtual address space in the exemplary embodiment;

FIG. 5A is a flowchart illustrating processing at the time of power saving mode operation in the exemplary embodiment;

FIG. 5B is a flowchart subsequent to FIG. 5A; and

FIG. 6 is a schematic block configuration diagram illustrating a main part of a conventional controller on which a plurality of CPUs are mounted.

### DETAILED DESCRIPTION

Hereinafter, a preferred exemplary embodiment of the present invention will be described with reference to the drawings.

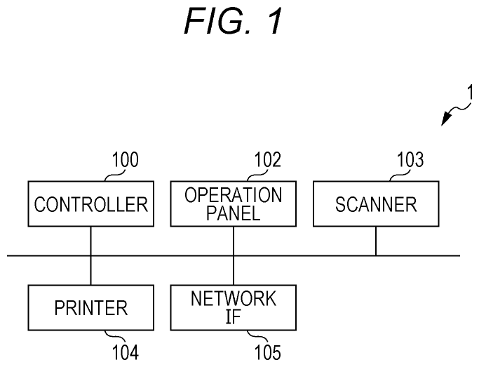

FIG. 1 is a schematic block configuration diagram illustrating a hardware configuration of an image forming apparatus 1 according to an exemplary embodiment. The image forming apparatus 1 is a multifunction machine having various functions such as a printing function, a copying function, and a scanner function, and is an apparatus including a computer. The image forming apparatus 1 includes a controller 100, an operation panel 102, a scanner 103, a printer 104, and a network interface (IF) 105. The controller 100 is a control board corresponding to the above-described computer.

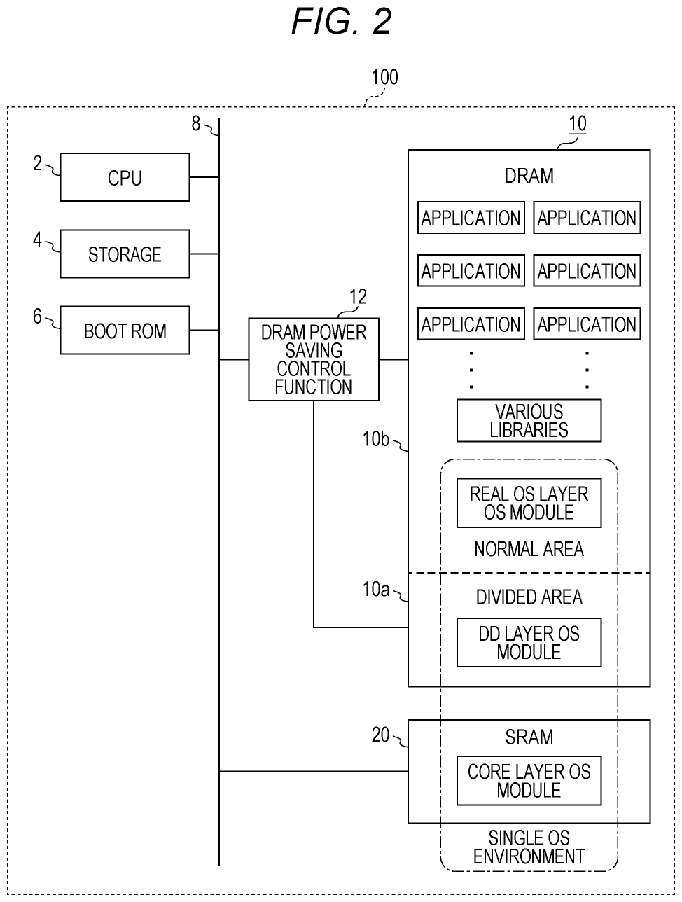

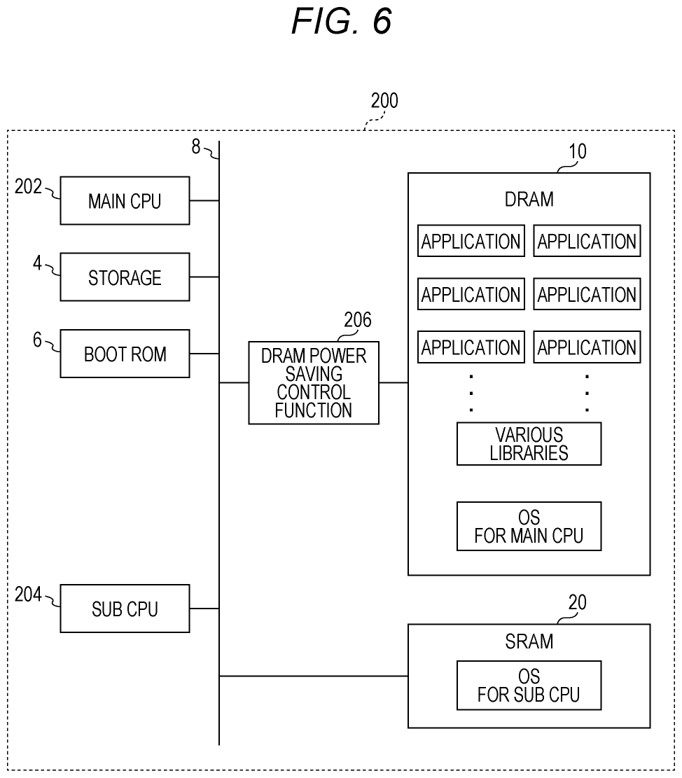

FIG. 2 is a block configuration diagram illustrating the controller 100 in the exemplary embodiment, and is a diagram corresponding to the controller 200 illustrated in FIG. 6. The same components as those of the controller 200 are denoted by the same reference numerals.

The controller 100 according to the exemplary embodiment is a control board on which a CPU 2, the storage 4, the boot ROM 6, a DRAM power saving control function 12, the DRAM 10, and the SRAM 20 are mounted, and these are connected to the control line 8. The DRAM 10 is connected to the control line 8 via the DRAM power saving control function 12. Components that are not used in the description of the exemplary embodiment are omitted from FIG. 2.

The CPU 2 performs operation control of various mechanisms mounted on the image forming apparatus 1, such as the scanner 103 and the printer 104, in accordance with an operating system (hereinafter, “OS”) or various libraries or applications (hereinafter, also simply referred to as “apps”) loaded in the DRAM 10 or the SRAM 20. The storage 4 is a storage means for storing software such as an application. The boot ROM 6 is a storage means for storing a computer program that is automatically executed immediately after the activation of the computer.

The DRAM (dynamic RAM) 10 is a volatile semiconductor storage device, and is divided into a second storage device and a third storage device to be controlled by the DRAM power saving control function 12 in the exemplary embodiment. The storage area corresponding to the second storage device in the exemplary embodiment is an area formed by being divided from the DRAM 10, and therefore, is referred to as a “divided area” 10a in the following description. On the other hand, in the exemplary embodiment, the storage area corresponding to the third storage device is a storage area other than the divided area 10a divided from the DRAM 10, and is an area into which an application or the like is normally loaded. Therefore, in the following description, the storage area is referred to as a “normal area” 10b.

The DRAM 10 according to the exemplary embodiment can operate in a self-refresh mode. The “self-refresh mode” is a mode in which a refresh instruction signal is automatically generated inside the DRAM 10 in a state where the DRAM 10 is not in operation to execute a refresh operation. The term “refresh” refers to an operation in which electric charge is periodically supplied to a memory cell so that data is periodically rewritten during operation. By refreshing, the data on DRAM 10 is saved without being deleted, and a power saving effect can be expected. The DRAM 10 according to the exemplary embodiment, in which power is not supplied after shifting to the power saving mode, is subjected to refresh control in the power saving mode.

The SRAM (static RAM) 20 is a volatile semiconductor storage device, and is provided as a first storage device that does not lose data without the refresh operation by being energized even in the power saving mode in the exemplary embodiment. Although the SRAM 20 is used as the first storage device in the exemplary embodiment, the DRAM 10 can be used in the power saving mode when the DRAM 10 is energized in the power saving mode in the same manner as in the normal mode.

The “power saving mode” is an operation mode different from the normal mode which is a normal state where a device such as the scanner 103 mounted on the image forming apparatus 1 can operate, and the power saving mode is an operation mode in which the image forming apparatus 1 enters a power saving state by stopping the supply of power to the devices such as the scanner 103. In the power saving mode according to the exemplary embodiment, control of the supply of power to the DRAM 10, which is described later, is performed. When a state where the image forming apparatus 1 does not operate for a predetermined time continues, the operation mode in the image forming apparatus 1 automatically shifts from the normal mode to the power saving mode. This restricts the operation of the function such as the scanner function provided by the image forming apparatus 1, but the power consumption is reduced.

The DRAM power saving control function 12 is a means for realizing a function of controlling power saving in the DRAM 10, which is characteristic in the exemplary embodiment, by hardware or software. The DRAM power saving control function 12 controls energization and self-refresh operation for each storage area formed by dividing the DRAM 10. In the exemplary embodiment, the divided area 10a and the normal area 10b can be individually controlled.

The OS is loaded into the volatile storage device when the image forming apparatus 1 is activated, but in the exemplary embodiment, a single OS is divided into a plurality of modules in accordance with the functions of the OS. Each module formed by the division is loaded into the DRAM 10 or the SRAM 20. Specifically, as illustrated in FIG. 2, the OS is divided into three layers of modules: a core layer, a device driver (DD) layer, and a real OS layer.

The core layer OS module is a module including a kernel forming a core of the OS, and is a first module having a function of detecting an interrupt due to reception of data. For example, an IO interrupt that occurs with detection of reception of a packet via a network as a trigger is detected. The core layer OS module is loaded to the SRAM 20 which can be used even in the power saving mode so that an interrupt can be detected in the power saving mode. Although the modules in the three layers may cooperate to realize kernel processing in the OS, the core layer OS module exhibits, among these, a function of detecting an IO interrupt, the function forming the core of the OS.

The DD layer OS module is a second module having a device driver function for controlling communication between hardware and software in response to a request from the core layer OS module. For example, the DD layer OS module receives the packet received by the core layer OS module and executes packet filtering processing. The “packet filtering processing” is one of network control functions of a communication device or a computer, and refers to processing of receiving or discarding data (that is, a packet) received from the outside in accordance with a certain standard set by an administrator or the like. The DD layer OS module is loaded in the divided area 10a.

The real OS layer OS module is a third module having a function of processing packet data generated by the DD layer OS module performing packet filtering processing in response to a request from the DD layer OS module or operating an application for processing the packet data. It can be said that the real OS layer OS module is a module that implements a function of the OS other than the functions of the core layer OS module and the DD layer OS module.

In the description of the exemplary embodiment, it is assumed that Linux (registered trademark), which is an open-source OS, is used as the OS, but the OS is not limited to Linux.

As described above, in the exemplary embodiment, a single OS is divided into the core layer OS module, the DD layer OS module, and the real OS layer OS module, which are loaded into the SRAM 20, the divided area 10a, and the normal area 10b, respectively, when the image forming apparatus 1 is activated. Software other than the OS, for example, various libraries and applications as illustrated in FIG. 2 are loaded into the normal area 10b and executed.

It is needless to say that the OS used in the exemplary embodiment is pre-installed in the image forming apparatus 1, and it is also possible to provide the OS via a communication means or store and provide the OS in a computer-readable recording medium such as a USB memory.

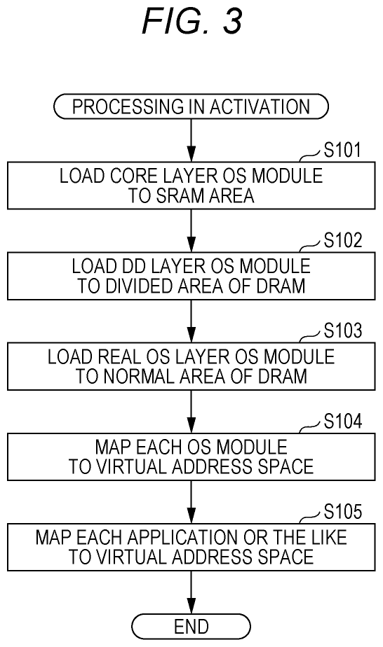

Next, the operation according to the exemplary embodiment will be described, but first, the operation at the time of activating the image forming apparatus 1 will be described with reference to the flowchart illustrated in FIG. 3.

When the image forming apparatus 1 is activated, the boot loader stored in the boot ROM 6 loads the OS stored in the storage 4 into the memory. That is, the boot loader loads the core layer OS module into the SRAM 20 (step S101), loads the DD layer OS module into the divided area 10a (step S102), and loads the real OS layer OS module into the normal area 10b (step S103). The boot loader knows the disposition address of each OS module on the physical address, and loads the OS module to the address position specified with the disposition address.

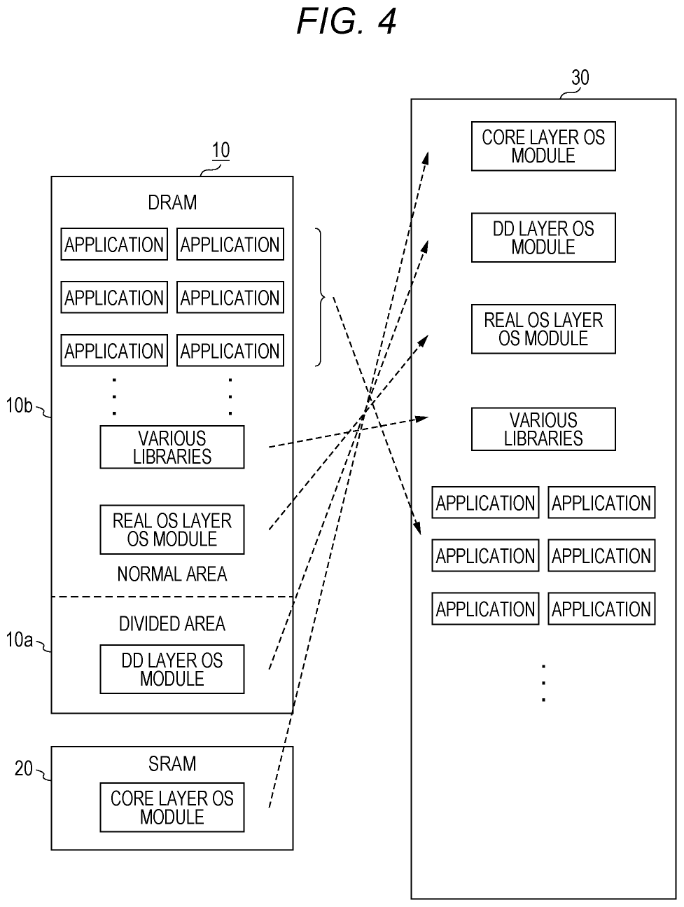

Subsequently, the boot loader maps each OS module to a virtual address space (step S104). Symbols such as functions and variables in each OS module are subjected to link processing so as to be referable/callable. When the loading of the OS is completed as described above, the OS initializes the system by mapping various libraries and applications to the virtual address space (step S105). The concept of the mapping to the virtual address space will be described with reference to FIG. 4.

In FIG. 4, the left side of the figure is the same as the DRAM 10 and the SRAM 20 illustrated in FIG. 2, and it corresponds to a so-called physical address space. The right side of the figure corresponds to the virtual address space. The size of the virtual address space depends on the amount of information that the CPU 2 can handle. For example, when the amount of information is expressed by 32 bits, the size of the virtual address space is 4G bytes. As indicated by dashed arrows in FIG. 4, the boot loader maps the core layer OS module, the DD layer OS module, and the real OS layer OS module in this order from the top address of a virtual address space 30. Subsequently, the boot loader maps various libraries and applications as necessary.

As described above, when the image forming apparatus 1 is powered on and activated, the OS modules constituting the OS are loaded into the SRAM 20, the divided area 10a of and DRAM 10, and the normal area 10b of the DRAM 10, and are mapped in the virtual address space. Then, the image forming apparatus 1 starts the operation in the normal mode.

Thereafter, when a predetermined condition for the image forming apparatus 1 to shift to the power saving mode is satisfied, for example, when there is no external input via the network for a predetermined time, the image forming apparatus 1 shifts from the normal mode to the power saving mode. At this time, the DRAM power saving control function 12 performs the self-refresh operation on all the areas of the DRAM 10, that is, both the divided area 10a and the normal area 10b. In this manner, since the DRAM 10 is not energized at the time of shifting to the power saving mode, the DD layer OS module and the real OS layer OS module are brought into an inoperable state. On the other hand, the energized state is continued in the SRAM 2. Thus, the core layer OS module can maintain a state of being able to cope with a data reception interrupt from the outside via a network.

According to the exemplary embodiment, since the power supply to the DRAM 10 can be stopped, the power saving effect can be enhanced accordingly.

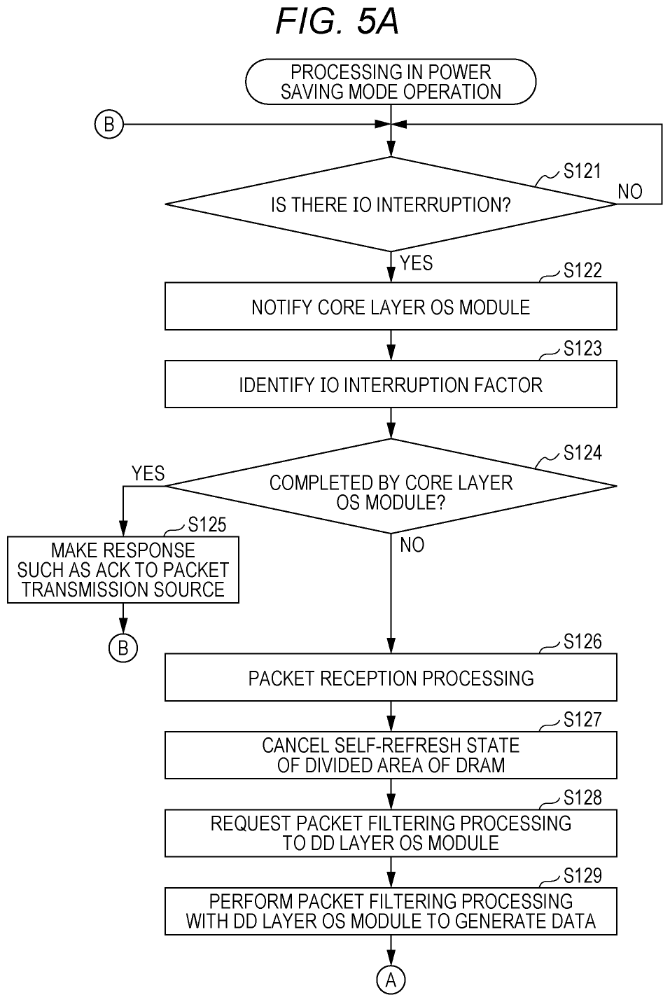

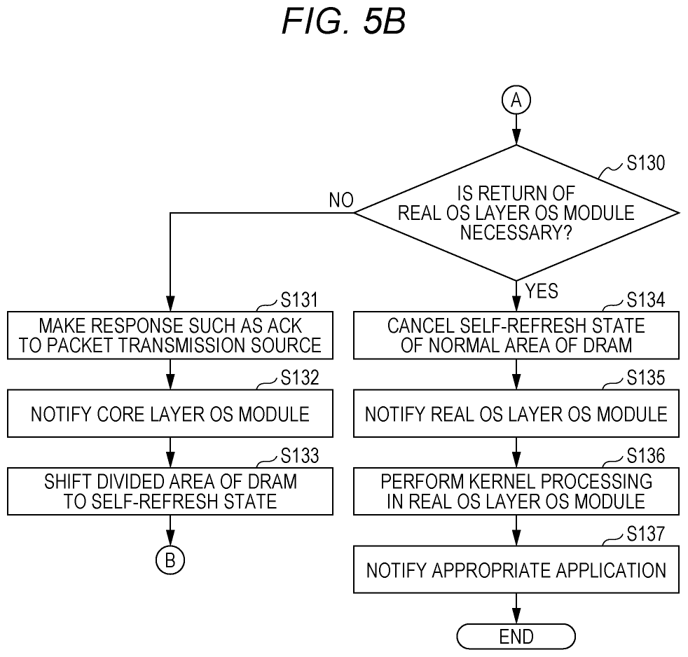

Hereinafter, the operation of the controller 100 in the power saving mode will be described with reference to the flowcharts illustrated in FIGS. 5A and 5B.

As described above, since the core layer OS module is loaded to the SRAM 20, even in the power saving mode, the core layer OS module can cope with a data reception interrupt (hereinafter, also referred to as an “IO interrupt”) from the outside via a network. The IO interrupt is detected by, for example, hardware, and the hardware notifies the core layer OS module that the IO interrupt has occurred. That is, the core layer OS module is in a standby state until an IO interrupt occurs (N in step S121). Then, with the occurrence of an IO interrupt (Y in step S121), when receiving a notification from the hardware (step S122), the core layer OS module detects the interrupt due to data reception. Here, a part of the data received by the IO interrupt, that is, a packet, is stored in a buffer in the SRAM 20. Subsequently, the core layer OS module identifies the occurrence factor of the IO interrupt (step S123). This identification method may be the same as a known method.

Here, when determining that the response to the occurred IO interrupt can be completed by the core layer OS module (Y in step S124), the core layer OS module makes a response such as ACK to the packet transmission source (step S125). Next, the controller 100 shifts to step 121 and returns to the standby state for an IO interrupt.

In this manner, according to the exemplary embodiment, since the controller 100 can respond to the data reception interrupt even when operating in the power saving mode, the controller 100 can receive packets transmitted from the outside without omission.

On the other hand, when determining that the response to the occurred IO interrupt cannot be completed by the core layer OS module (N in step S124), the core layer OS module subsequently executes packet reception processing for receiving all the packets constituting the data (step S126). The DRAM power saving control function 12 stops the refresh operation in the divided area 10a in response to an instruction from the core layer OS module, and cancels the refresh state (step S127). This causes the DD layer OS module loaded in the divided area 10a to return from the inoperable state to the normal state in which the DD layer OS module is operable. Then, the core layer OS module passes the received packet to the DD layer OS module, and requests packet filtering processing (step S128). In response to the request, the DD layer OS module performs packet filtering processing to generate data (step S129). For example, a device driver of the network interface 105 analyzes the packet received via the network and generates reception data.

The DD layer OS module determines whether return of the real OS layer OS module is necessary, for example, whether it is necessary to use an application when processing the generated reception data. This is the same as the determination of the core layer OS module in step S124, and can also be said to be determination of whether the response to the generated reception data can be completed by the DD layer OS module.

Here, when it is determined that the return of the real OS layer OS module is not necessary (N in step S130), the DD layer OS module makes a response such as ACK to the packet transmission source (step S131), and notifies the core layer OS module that the processing in the DD layer OS module has been completed (step S132). Upon receiving the notification from the DD layer OS module, the core layer OS module can determine that the operation in the DD layer OS module has become unnecessary, and thus causes the DRAM power saving control function 12 to perform a self-refresh operation on the divided area 10a of the DRAM 10. That is, the DD layer OS module shifts to the self-refresh state and becomes the power saving state (step S133).

On the other hand, when it is determined that the return of the real OS layer OS module is necessary (Y in step S130), the DRAM power saving control function 12 stops the refresh operation in the normal area 10b in response to an instruction from the DD layer OS module and cancels the refresh state (step S134). That is, at the time point when the return of the real OS layer OS module becomes necessary, the power saving state in the entire DRAM 10 is canceled.

With the cancel of the power saving state, the real OS module loaded in the normal area 10b returns from the inoperable state to the normal state in which the real OS module is operable. Then, the DD layer OS module passes the generated date to the real OS layer OS module, and notifies the real OS layer OS module to perform data processing (step S135). In response to the notification, the real OS layer OS module executes kernel processing in the real OS layer OS module (step S136). In the kernel processing in the real OS layer OS module, when an application is required for data processing, the application whose operation is determined to be required is specified, and allocation of a virtual address space, scheduling of a thread, and the like are performed. Then, the real OS layer OS module notifies the application to perform data processing (step S137). Upon receiving the notification, the application starts operating under the operation control of the real OS layer OS module, and performs predetermined data processing on the data.

When the real OS layer OS module is in an operable state, since the entire SRAM 20 is energized in addition to the DRAM 10 at this time, the power saving state of the controller 100 is canceled, and the controller 100 operates in a normal state. Thus, the power saving mode processing ends.

In this manner, according to the exemplary embodiment, when an IO interrupt is detected by the core layer OS module in the power saving mode, the refresh of the divided area 10a or the normal area 10b, in which the module necessary for processing the data formed of the received packet is loaded, among the divided area 10a and the normal area 10b, is canceled. Specifically, when the core layer OS module determines that the DD layer OS module is needed for data processing, the core layer OS module cancels the refresh of the divided area 10a. When the DD layer OS module determines that the real OS layer OS module is needed for data processing, the DD layer OS module cancels the refresh of the normal area 10b. In this manner, in the exemplary embodiment, only the storage areas 20, 10a, and 10b in which necessary OS modules are loaded are made operable, thereby improving the power saving effect.

According to the exemplary embodiment, since a single OS is used, the software configuration can be simplified, and since only a single CPU 2 needs to be installed and operated in the image forming apparatus 1, the occurrence of packet loss can be suppressed.

In the exemplary embodiment, the DRAM 10 is divided, and the DD layer OS module is loaded into the divided area 10a formed by the division. When the SRAM 20 has a sufficient storage area capacity, the DD layer OS module may be loaded to the SRAM 20.

In the above description, the real OS layer OS module is loaded into the normal area 10b of the DRAM 10 together with various libraries and applications. However, a configuration may be adopted in which an area other than the divided area 10a of the DRAM 10 is subdivided, and the real OS layer OS module is loaded into a divided area different from the various libraries and applications. That is, the DRAM 10 may be divided into three or more areas, the software to be loaded into the normal area 10b may be classified according to the function or the like, and the classified software may be loaded into each of the storage areas formed by the subdivision.

The “information processing system” in the exemplary embodiment is described as being configured by a single image forming apparatus 1 as an example, but it may be configured by an information processing apparatus such as a PC.

In the exemplary embodiment described above, the processor refers to a processor in a broad sense, including general-purpose processors (for example, CPU: central processing unit) and dedicated processors (for example, GPU: graphics processing unit, ASIC: application specific integrated circuit, FPGA: field programmable gate array, and programmable logic devices).

### Supplementary Note

(((1)))

An information processing system comprising:
a processor;
a first storage device that is volatile and does not lose data with energization in a power saving mode; and
a second storage device and a third storage device that are volatile and subjected to a refresh control in the power saving mode,
wherein
the processor,
when activated,
loads, into the first storage device, a first module having a function of detecting an interrupt due to reception of data among modules formed by dividing an operating system according to a function of the operating system,
loads, into the second storage device, a second module having a function of controlling communication between hardware and software in response to a request from the first module,
loads, into the third storage device, a third module having a function of processing the data or operating an application for processing the data in response to a request from the second module,
causes the second storage device and the third storage device to perform a refresh operation in the power saving mode, and
when the interrupt is detected by the first module in the power saving mode, cancels refresh of a storage device among the second storage device and the third storage device in which a module required for processing the data is loaded.
(((2)))

The information processing system according to (((1))), wherein
when the interrupt is detected by the first module in the power saving mode, the processor
cancels refresh of the second storage device when the processor determines that the second module is needed for processing the data, and
cancels refresh of the third storage device when the second module determines that the third module is needed for processing the data.
(((3)))

The information processing system according to (((1))) or (((2))), wherein
the processor,
when activated, loads the application into the third storage device, and
operates the application that is determined to be required to operate by the third module.
(((4)))

The information processing system according to any one of (((1))) to (((3))), wherein
the first module includes a kernel,
the second module includes a device driver, and
the third module includes a module other than the kernel and the device driver in the operating system.
(((5))

The information processing system according to any one of (((1)) to ((4))), wherein
the second storage device and the third storage device are formed by dividing one DRAM into two areas, and
the processor performs the refresh control for each of the areas.
(((6)))

The information processing system according to (((5))), wherein
the processor
causes the DRAM to perform a refresh operation in the power saving mode, and
when the first module has detected the interrupt in the power saving mode and the processor determines that the second module is needed for processing the data, cancels refresh of only an area in which the second module is loaded in the DRAM.
(((7)))

A non-transitory computer-readable storage medium storing a program for causing a computer including:
a processor;
a first storage device that is volatile and does not lose data with energization in a power saving mode; and
a second storage device and a third storage device that are volatile and subjected to a refresh control in the power saving mode,
to realize, when activated,
a function of loading, into the first storage device, a first module having a function of detecting an interrupt due to reception of data among modules formed by dividing an operating system according to a function of the operating system,
a function of loading, into the second storage device, a second module having a function of controlling communication between hardware and software in response to a request from the first module,
a function of loading, into the third storage device, a third module having a function of processing the data or operating an application for processing the data in response to a request from the second module,
a function of causing the second storage device and the third storage device to perform a refresh operation in the power saving mode, and
a function of canceling, when the interrupt is detected by the first module in the power saving mode, refresh of a storage device among the second storage device and the third storage device in which a module required for processing the data is loaded.
(((8)))

An information processing method, wherein
a processor included in an information processing system together with a first storage device that is volatile and does not lose data with energization in a power saving mode and a second storage device and a third storage device that are volatile and subjected to a refresh control in the power saving mode,
when activated,
loads, into the first storage device, a first module having a function of detecting an interrupt due to reception of data among modules formed by dividing an operating system according to a function of the operating system,
loads, into the second storage device, a second module having a function of controlling communication between hardware and software in response to a request from the first module,
loads, into the third storage device, a third module having a function of processing the data or operating an application for processing the data in response to a request from the second module,
causes the second storage device and the third storage device to perform a refresh operation in the power saving mode, and
when the interrupt is detected by the first module in the power saving mode, cancels refresh of a storage device among the second storage device and the third storage device in which a module required for processing the data is loaded.

What is claimed is:

1. An information processing system comprising:
a processor;
a first storage device that is volatile and does not lose data with energization in a power saving mode; and
a second storage device and a third storage device that are volatile and subjected to a refresh control in the power saving mode,
wherein
the processor,
when activated,
loads, into the first storage device, a first module having a function of detecting an interrupt due to reception of data among modules formed by dividing an operating system according to a function of the operating system,
loads, into the second storage device, a second module having a function of controlling communication between hardware and software in response to a request from the first module,
loads, into the third storage device, a third module having a function of processing the data or operating an application for processing the data in response to a request from the second module,
causes the second storage device and the third storage device to perform a refresh operation in the power saving mode, and
when the interrupt is detected by the first module in the power saving mode, cancels refresh of a storage device among the second storage device and the third storage device in which a module required for processing the data is loaded.

2. The information processing system according to claim 1, wherein
when the interrupt is detected by the first module in the power saving mode, the processor
cancels refresh of the second storage device when the processor determines that the second module is needed for processing the data, and
cancels refresh of the third storage device when the second module determines that the third module is needed for processing the data.

3. The information processing system according to claim 2, wherein
the processor,
when activated, loads the application into the third storage device, and
operates the application that is determined to be required to operate by the third module.

4. The information processing system according to claim 1, wherein
the first module includes a kernel,
the second module includes a device driver, and
the third module includes a module other than the kernel and the device driver in the operating system.

5. The information processing system according to claim 1, wherein
the second storage device and the third storage device are formed by dividing one DRAM into two areas, and
the processor performs the refresh control for each of the areas.

6. The information processing system according to claim 5, wherein
the processor
causes the DRAM to perform a refresh operation in the power saving mode, and
when the first module has detected the interrupt in the power saving mode and the processor determines that the second module is needed for processing the data, cancels refresh of only an area in which the second module is loaded in the DRAM.

7. A non-transitory computer-readable storage medium storing a program for causing a computer including:
a processor;
a first storage device that is volatile and does not lose data with energization in a power saving mode; and
a second storage device and a third storage device that are volatile and subjected to a refresh control in the power saving mode,
to realize, when activated,
a function of loading, into the first storage device, a first module having a function of detecting an interrupt due to reception of data among modules formed by dividing an operating system according to a function of the operating system,
a function of loading, into the second storage device, a second module having a function of controlling communication between hardware and software in response to a request from the first module,
a function of loading, into the third storage device, a third module having a function of processing the data or operating an application for processing the data in response to a request from the second module,
a function of causing the second storage device and the third storage device to perform a refresh operation in the power saving mode, and
a function of canceling, when the interrupt is detected by the first module in the power saving mode, refresh of a storage device among the second storage device and the third storage device in which a module required for processing the data is loaded.

8. An information processing method, wherein
a processor included in an information processing system together with a first storage device that is volatile and does not lose data with energization in a power saving mode and a second storage device and a third storage device that are volatile and subjected to a refresh control in the power saving mode,
when activated,
loads, into the first storage device, a first module having a function of detecting an interrupt due to reception of data among modules formed by dividing an operating system according to a function of the operating system,
loads, into the second storage device, a second module having a function of controlling communication between hardware and software in response to a request from the first module,
loads, into the third storage device, a third module having a function of processing the data or operating an application for processing the data in response to a request from the second module,
causes the second storage device and the third storage device to perform a refresh operation in the power saving mode, and
when the interrupt is detected by the first module in the power saving mode, cancels refresh of a storage device among the second storage device and the third storage device in which a module required for processing the data is loaded.
